(19) United States
(12) Patent Application Publication
(10) Pub. No.: US 2008/0161054 A1
(43) Pub. Date: Jul. 3, 2008

(54) Node selection function for multipoint radio network configurations

(75) Inventors: Juha Kallio, Helsinki (FI); Markus Martin, Helsinki (FI); Janne Muhonen, Espo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/647,425

(22) Filed: Dec. 29, 2006

(51) Int. Cl. H04M 7/00

(52) U.S. Cl. 455/560

(57) ABSTRACT

An apparatus is configured to be operably connected to an access network controller device as well as to a pool of network elements which all comprise the same radio network configuration. The apparatus further comprises a selection functionality configured to select and connect one or more of the network elements with the access network controller device.

### FIELD OF THE INVENTION

The present invention relates to an apparatus, a system and a method which are suitable for enhancing the resiliency in a communication network.

### RELATED BACKGROUND ART

The mobile switching center server (MSC server—MSS) architecture is an enhancement on top of traditional circuit switched networks where both switching of actual user plane traffic (i.e. speech, data and facsimile) as well as control plane traffic (i.e. call and non-call related signaling) has been split into separate physical (and logical) entities which are called as media gateway (MGW) and MSC Server.

This split enables multiple different benefits for the network operator compared to a situation where traditional MSC network elements are used instead. For instance, the MSC server system makes it possible to use an internet protocol (IP), asynchronous transfer mode (ATM) or time divisional multiple access (TDM) transmission to transport signaling and user plane traffic the standardized way. This has not been possible in earlier occasions, even though there have been some vendor specific solutions. Another benefit is the more optimal use of core network resources. For instance, the MSC server capacity i.e. call control, charging and services capacity can be obtained and controlled separately from the switching capacity needed for connecting calls (e.g. speech connections). This makes it more easier for an operator to design the network topology and place MGW network elements into locations that are more optimal for actual switching process, whereas the call control can be centralized within the network into a smaller number of central office sites.

In addition to previously mentioned benefits, the use of MSC server system is expected to allow more freedom to design more advanced solutions for network resiliency. At present, this particular area has not been known yet to be studied in greater detail by the 3^{rd} generation partnership project. However, when in principle traditional (non-split) MSC have been present in existing mobile networks, network resiliency has conventionally been done for signaling connections and in rare cases by dedicating some MSC into the network which is able to take traffic from a faulty network element, in case failure occurs at the network. This procedure is by no means simple to execute and has many possibilities to fail. Therefore, operators have not used it, but instead moved only individual radio network configurations (manually, not automatically) from faulty MSC to other MSC, if the failure is estimated to last long enough. Fact is that network operators are expecting to have better network element and even network level resiliency solutions from their equipment vendors, because the network element sizes are constantly increasing (handling even millions of subscribers within a single network element), and in case of a failure thus having a catastrophic magnitude, the income losses together with a hit to the overall image of an operator's business can be very significant.

In principle, this situation is the same in case of using a MSC server. However, because the MSC server system consists of multiple MSC servers that are responsible of actual call routing etc., as well as of media gateways (MGW) that are responsible of user plane switching, it is possible that MGW and/or MSC server or connections between them can be lost, resulting in a lack of communication capabilities for a certain part of overall traffic. In both specifications 3GPP TS 29.232 and TS 29.332 of MGW, individual physical MGW can be split into multiple virtual MGW each having its own share of responsibility for switching the total traffic of physical MGW. Virtual MGW are controlled by individual MSC server entities. A single physical MSC server can control multiple virtual MGW (even from the same physical MGW). Each virtual MGW is nominated to be responsible of individual TDM circuits (pulse code modulated (PCM) timeslots), but ATM and IP resources are freely usable for all virtual MGW located within the same physical MGW. Because of this restriction, for instance in case the connection between a specific virtual MGW and the MSC server that controls it is down, those TDM resources (PCM timeslots) that have been designated to that particular virtual MGW are out-of-use until the situation is restored back into normal or the resource ownership of those resources is moved into another (working) virtual MGW-MSC server pair. Therefore, also within the MSC server system (if overall network level resiliency enhancements are considered) manual re-homing of both radio network resources (in case of MSC server failure) and TDM-resources is typically the only possible solution to provide network level resiliency in case for some reason the MSC server or virtual MGW responsible of those resources cannot be used.

GSM (global system for mobile communication)/GPRS (general packet radio service)/EDGE (enhanced data rates for GSM evolution) and UMTS (universal mobile telecommunications service) radio access network configurations are typically in today's networks dedicated for single MSC or MSC server. The MSC server knows the radio network assigned to it, but in addition to this it also has information about the neighbor radio network configuration of other neighbor MSC or MSC server network elements. Due this fact that no single radio network controller (RNC) or base station controller (BSC) is controlled by more than one circuit switched core network and packet switched core network element (MSC/MSC server and SGSN), it will cause situations where the loss of a core network element or connection towards core network from RNC/BSC seizes the communication from that radio network controlled by a particular RNC/BSC.

### SUMMARY OF THE INVENTION

Therefore, it is an object of the present invention to overcome respective shortcomings of the prior art. Specifically, the present invention aims at enhancing the resiliency of a communication network.

According to a first aspect of the present invention, there is provided an apparatus configured to be operably connected to an access network controller device; and to be operably connected to a pool of network elements which all comprise the same radio network configuration; the apparatus further comprising a selection functionality configured to select and connect one or more of the network elements with the access network controller device.

Modifications of the first aspect of the present invention may be as follows.

The selection functionality can be a non-access stratum node selection functionality.

The apparatus according to the first aspect can be further configured to be operably connected to a radio network controller and a base station controller.

The network elements can be selected from a group comprising serving GPRS support nodes and mobile switching center server.

The apparatus according to the first aspect can be further configured to be operably connected to a pool of network elements over a multipoint interface.

The apparatus according to the first aspect can be further configured to process protocol parameter out of the group comprising temporary mobile station identity, international mobile subscriber identity, and intra domain non-access stratum node selector at level 3 signaling.

The apparatus according to the first aspect can be further configured to support one or more of the group comprising radio access network application part, base station system application part, and base station system GPRS protocol.

According to a second aspect of the present invention, there is provided a system comprising an access network controller device; a pool of network elements which all comprise the same radio network configuration; and a gateway, configured to be operably connected to the access network controller device, as well as to the pool of network elements, wherein the gateway further comprises a selection functionality configured to select and connect one or more of the network elements with the access network controller device.

Modifications of the second aspect of the present invention can be as follows.

The selection functionality can be a non-access stratum node selection functionality.

The gateway can be further configured to be operably connected to a radio network controller and a base station controller.

The network elements can be selected from a group comprising serving GPRS support nodes and mobile switching center server.

The gateway can be further configured to be operably connected to a pool of network elements over a multipoint interface.

The gateway can be further configured to process protocol parameter out of the group comprising temporary mobile station identity, international mobile subscriber identity, and intra domain non-access stratum node selector at level 3 signaling.

The gateway can be further configured to support one or more of the group comprising radio access network application part, base station system application part, and base station system GPRS protocol.

The system according to the second aspect can comprise at least two gateways, each of which is configured to be operably connected to the access network controller device, as well as to the pool of network elements, and each of which comprises a selection functionality configured to select and connect one or more of the network elements with the access network controller device.

According to a third aspect of the present invention, there is provided a method comprising selecting one or more network elements out of a pool of network elements which all comprise the same radio network configuration; and connecting the selected one or more network elements with an access network controller device via a gateway.

Modifications of the third aspect of the present invention can be as follows.

The selecting of one or more network elements can involve a non-access stratum node selection functionality.

The access network controller device can be one of a radio network controller and a base station controller.

The selecting of network elements can include selecting core network elements from a group comprising serving GPRS support nodes and mobile switching center server.

The connecting of the selected one or more network elements can include connecting to a pool of core network elements over a multipoint interface.

The method according to the third aspect can further comprise processing, by the gateway, protocol parameter out of the group comprising temporary mobile station identity, international mobile subscriber identity, and intra domain non-access stratum node selector at level 3 signaling.

The method according to the third aspect can further comprise supporting, by the gateway, one or more of the group comprising radio access network application part, base station system application part, and base station system GPRS protocol.

The method according to the third aspect can further comprise providing at least two gateways, each of which is configured to be operably connected to the access network controller device, as well as to the pool of network elements, and each of which comprises a selection functionality configured to select and connect one or more of the network elements with the access network controller device.

According to a fourth aspect of the present invention, there is provided an apparatus, comprising means for operably connecting to an access network controller device; means for operably connecting to a pool of network elements which all comprise the same radio network configuration; and means for selecting and connecting one or more of the network elements with the access network controller device.

According to a fifth aspect of the present invention, there is provided a system comprising means for providing access network control; a plurality of means for providing network services which all comprise the same radio network configuration; and gateway means for connecting to the means for providing access network control, as well as to the plurality of means for providing core network services, wherein the gateway means comprise means for selecting and connecting one or more of means for providing network services with means for providing access network control.

According to a sixth aspect of the present invention, there is provided a computer program product embodied on a computer-readable medium, the computer program product configured to provide a method comprising selecting one or more network elements out of a pool of network elements which all comprise the same radio network configuration; and connecting the selected one or more network elements with an access network controller device via the media gateway.

### BRIEF DESCRIPTION OF THE DRAWINGS

The above and further aspects, features, and advantages of the present invention will become readily apparent from the following description of its preferred embodiments which is to be taken in conjunction with the appended drawings, in which:

FIG. 1 shows multipoint A/Gb and Iu interface features as defined by the 3GPP;

FIG. 2 shows enhancements according to an embodiment of the present invention with respect to the previous architecture which provide MSC server level resiliency; and

FIG. 3 shows an additional enhancement according to another embodiment of the present invention in order to achieve MGW-level resiliency.

### DETAILED DESCRIPTION OF THE PREFERRED EMBODIMENTS

The preferred embodiments described in the following serve to illustrate the applicability and enablement of the present invention, but it is to be expressly understood that these embodiments are meant to serve as illustrative examples only, and that they are by no means to be construed as limiting the present invention to the described particularities.

The technical specification 23.236 of the 3GPP (“Intra-domain connection of Radio Access Network (RAN) nodes to multiple Core Network (CN) nodes”) introduces a so-called multipoint A or multipoint Iu-interface, which enables a RNC or BSC to be connected to multiple core network elements (both MSC/MSC server as well as SGSN). Accordingly, the resiliency of the network is enhanced in case a fatal failure situation occurs towards specific core network elements. The main principle of these features is that RNC/BSC is configured to communicate towards a pool of network elements (with individual pools for both circuit switched (CS) and packet switched (PS) traffic), where core network elements within the same pool are configured with the same radio network configuration i.e. are able to handle traffic from that particular RNC/BSC.

Both RNC and BSC that support multipoint A or multipoint Iu interface features have to have a so-called non access stratum (NAS) node selection function (NSF). This function is the key to select the proper core network element to be used to provide services for a particular terminal, and it is executed when this terminal contacts the RNC/BSC the first time without already providing any information about a possibly selected core network element. When the RNC/BSC notices that the terminal has not yet been nominated to any specific core network element within a respective pool, then it will nominate the network element based on some non-standardized algorithm (e.g. round-robin or even something more sophisticated that takes into account the load of individual elements within a pool) and forwards the messages from the terminal to the selected core network element. The core network element then will check whether or not the terminal/subscriber is entitled to use services from the core network, and allocate a temporary mobile station identity (TMSI) to the terminal including a so-called network resource identifier (NRI) value embedded within the TMSI value. The TMSI is received by the terminal from the network and stored normally for further use. It needs to be highlighted that the terminal does not have to understand about the NRI value embedded within the stored TMSI. It only needs to use that TMSI for further communication towards the network.

The NRI value, which is embedded into the TMSI, is received later by the RNC/BSC and analyzed in order to find out which core network element is dedicated for the CS and for the PS traffic (both CS and PS may have individual, i.e. different, NRI values and therefore need to be handled separately). The RNC/BSC forwards the message to the corresponding core network element and thus the logical communication path between terminal and the core network is maintained as long as the terminal stays within the area of a same pool. It should also be remarked that during a time period when the terminal stays within a same pool area, the same CS and PS core network elements remain to be responsible of the terminal. This means that e.g. no inter-MSC/MSC Server handovers are executed. This also reduces the overall signaling traffic and the handover processing needed for handovers compared to the traditional configuration where movement from the area of one core network element to another caused an immediate handover.

In case the terminal moves to the area controlled by another pool of core network elements, then the NRI allocation process is re-executed again between the terminal and the core network. Similarly, when the RNC/BSC notices that a RANAP (radio access network application part) or BSSAP (base station system application part) connection towards a specific core network element for some reason within a pool has been lost, it is possible for the RNC/BSC to forward signaling traffic from the terminal towards another core network element within the same pool. This way it is possible to increase the overall network level resiliency with the introduction of the multipoint interface features.

However, when the multipoint A or Iu interface features are taken into use, the configuration of the radio network becomes a very critical issue. Thus, for the location area, the cell identifier, the RNC/BSC, the service area, the base station etc., the radio network configuration at core network side has to be same in all network elements belonging to a same pool. In addition to this, each core network element has to have its own unique NRI configuration. One network element can have one or more NRI values, which are then embedded within allocated TMSI. The number of NRI values owned by a single core network element can be used to fine-tune how terminals are divided within a pool (a network element having more NRI values may be selected more often to handle terminals than a network element having less NRI values). Each core network element also needs to be aware of NRI values of other network elements within the same pool in order to forward signaling messages to a correct network element, if so needed.

The RNC/BSC also needs to be able to determine which core network element (CS and PS) corresponds to which NRI value. These values are statically pre-configured into RNC/BSC network elements and used by the RNC/BSC to route signaling messages to a correct network element from the terminal. In case the RNC/BSC receives a value that it does not recognize (i.e. a NRI belonging to some other pool), then the RNC/BSC need to act as if no NRI value has been received, and consequently, to use the NAS node selection function to select a new core network element from the pool that it can communicate with. The RNC/BSC is assumed not to maintain any subscriber/terminal specific information due to the multipoint A or Iu interface features, and all signaling transactions between the terminal and the core network can be executed with simple lookups into a NRI/core network element correspondence database.

However, the above described multipoint interface features are still problematical because those require support from radio network controllers (RNC/BSC), core network elements (MSC or MSC Servers and SGSN) as well as network management systems (NMS) in order to configure a whole feature into use with a reasonable amount of time and risk.

For instance, core network elements may already support multipoint features, but a feature support might be missing from the radio network and NMS parts.

An embodiment of the present invention is to offer an alternative way to overcome the problem related to lack of support at the radio network side which may be considered as being relatively harmful, because such lack of support will completely prevent use of the above described multipoint interface features.

According to this embodiment, the NAS node selection function and the intelligence related to the routing of signaling messages towards a correct core network element based on a NRI value used by the RNC/BSC network elements (i.e. radio network) may be implemented into a media gateway (MGW) network element as introduced with the MSC server system.

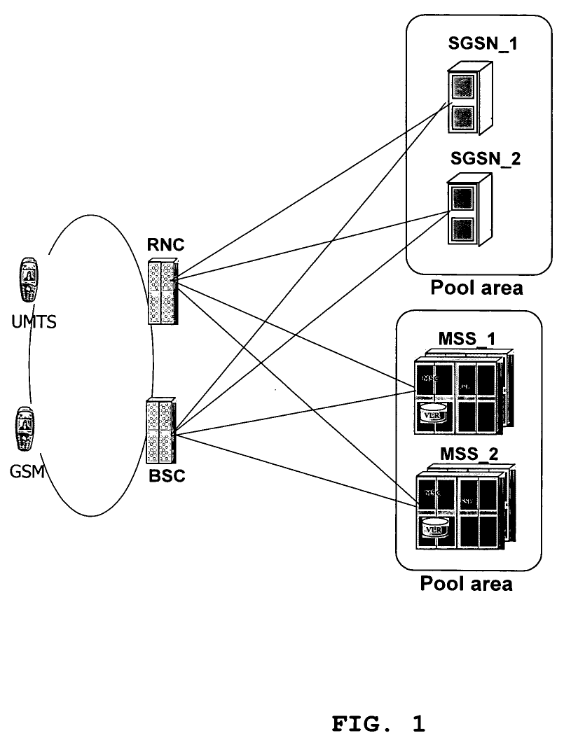

For comparison purposes, FIG. 1 shows the above described situation where the NAS node selection function (NAS-NSF) is located in the RNC or BSC and the RNC/BSC has connections to multiple CS (MSS_1, MSS_2) and PS (SGSN_1, SGSN_2) network elements that are pooled (within a so-called pool area).

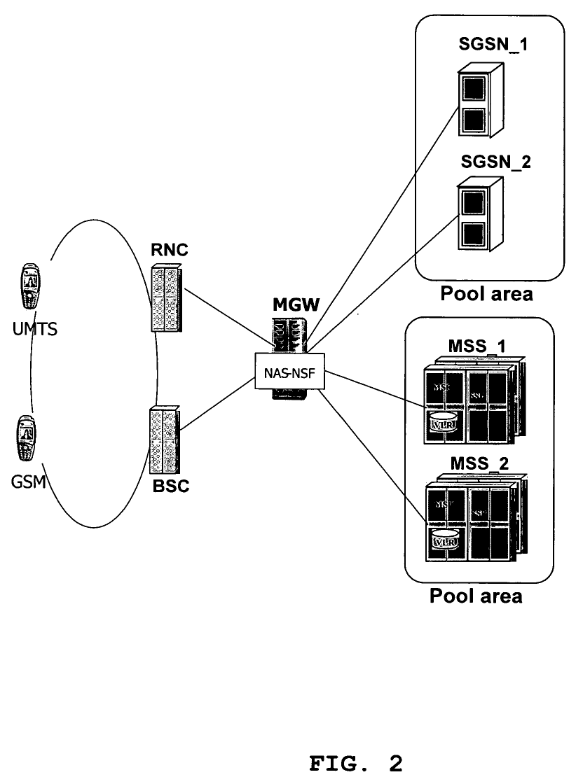

FIG. 2 shows the situation according to the present embodiment. The present embodiment includes that there is a MSC server system or 2G/3G packet switched core network having support for an appropriate multipoint interface feature (A or Iu). However, no support is needed for this feature from RNC or BSC, which is an important benefit of the present embodiment.

Thus, the effect of the network having enhanced resiliency against MSC server-level outages (or an outage of connection between the MSC server and the MGW) is achieved according to the present embodiment.

Moreover, a further embodiment of the present invention considers having resiliency against MGW-level outages. This may be achieved by defining multiple MGW with same NAS-NSF capability and same signaling point code as well as showing global network identifier towards RNC/BSC.

An implementation example would be to enhance the signaling point management cluster (SPMC) such as is defined by the IETF in document RFC3332 to support multiple signaling gateway entities within a single SPMC cluster.

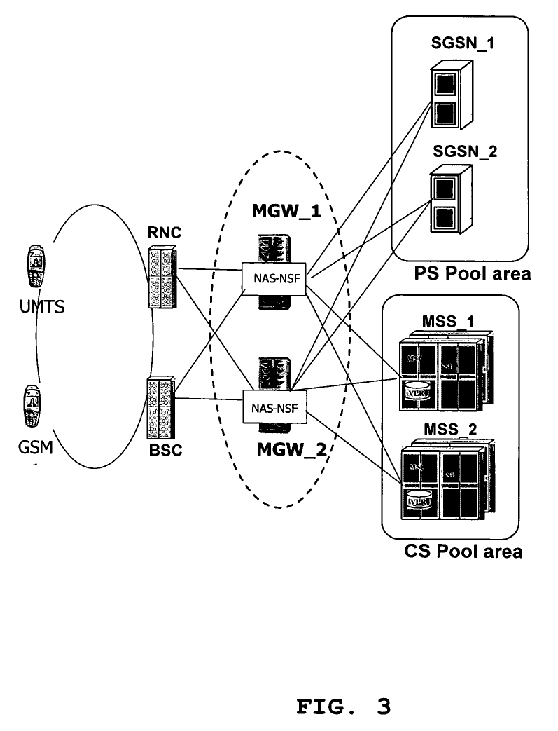

This further embodiment is depicted in FIG. 3 by means of an example including two MGW, MGW_1 and MGW_2. Accordingly, network resiliency architecture is provided at the MGW level.

In the following, the description is limited to the above described embodiment shown in FIG. 2 which provides a MSC server-level resiliency, whereas no detailed description is further provided about the MGW-level resiliency shown in FIG. 3. However, it is apparent that a similar description applies to the case shown in FIG. 3.

It is to be noted that due to the fact that neither RNC nor BSC need to have a functionality implemented about the pool concept or NRI, the MGW having the built-in NAS-NSF has to be able to act as a router for both RANAP and BSSAP level protocol messages between the correct core network element and the RNC/BSC.

It is an option that a pool is configured for a MGW with more than two core network elements (MSC server or SGSN). However, some maximum limitation of pool size can be implemented. Typically, such value can be e.g. that a single pool has a maximum of ten different network elements for circuit switched and ten for packet switched networks. An advantage would be to provide the needed capacity requirements for the internal database structure of the MGW which is required for storing the relationship between the NRI and the core network element.

In the MSC server system, the MGW is the network element that has the physical connectivity from RNC/BSC and also acts as signaling gateway for signaling traffic between the radio network and the circuit switched core network. In some cases, the MGW can be also used to act as transmission multiplexer for Iu-PS and Gb traffic (if over frame relay) as well. Accordingly, the need for separate transmission cabling from RNC/BSC towards both MGW and SGSN can be reduced. Moreover, the MGW also can be responsible of switching actual user plane connections between the radio access network and the core network. Further, in case the speech codecs which are used at the radio network side and at the core network side are different, the MGW also can be responsible of speech transcoding between speech codecs. The MGW performs the control on the basis of H.248 commands received from the MSC server. In case a specific MSC server becomes unavailable for traffic, then the MGW notices the situation from events caused by an H.248 protocol entity within MGW, before anything unusual is noticed by RANAP or BSSAP entities and the NAS-NSF of the MGW. In this case, one option is that the NAS-NSF located at the MGW does not try to reselect another core network element, but instead waits for loss of connectivity-events that occur at RANAP or BSSAP level towards the core network element.

According to an implementation example, the MGW is enhanced with a specific understanding about the required protocol parameters (TMSI, IMSI (international mobile subscriber identity) and IDNSS (intra domain NAS node selector) at level 3 (L3) signaling) in order to behave correctly, i.e. to be able to route the signaling messages to the correct network elements (i.e. to use NRI), and to allocate the proper core network element, if no specific core network element has been yet nominated for that terminal from the given pool. Therefore, the MGW investigates RANAP or BSSAP level information and thus supports required parts of RANAP and BSSAP protocols which are implemented into the MGW.

In order to support packet switched multipoint interface features in addition, also BSSGP (bas station system GPRS protocol) and RANAP according to the Iu PS interface are supported within the MGW.

Furthermore, the MGW can also be enabled to separate both PS and CS level signaling and to have knowledge of the relationship between a NRI and a particular PS or CS network element as pre-configured by the network operator, i.e. to have individual pools for both CS and PS network sides.

It is to be noted, however, that it is a possible implementation option that only CS side traffic is handled as multipoint traffic and the PS side traffic is handled normally such as between RNC/BSC and only a single SGSN.

Still another implementation example is to introduce M3UA (message transfer part 3 user adaptation)/SIGTRAN procedures into the integrated signaling gateway functionality of the MGW to cope automatic changes within the M3UA network topology (i.e. events such as loss of connection towards individual application server processes (ASP) etc.).

According to the above described embodiments, the MSC server system can be enhanced in order to make multipoint Iu or A interface features available, regardless of an availability of these features at the radio network side. It is another advantage of the above described embodiments that the MSC server level improvement can be implemented independently of a later support of MGW-level resiliency.

Thus, according to embodiments of the present invention, an apparatus is configured to be operably connected to an access network controller device as well as to a pool of network elements which all comprise the same radio network configuration. The apparatus further comprises a selection functionality configured to select and connect one or more of the network elements with the access network controller device.

What has been described above is what is presently considered to be preferred embodiments of the present invention. However, as is apparent to the skilled reader, these are provided for illustrative purposes only and are in no way intended to that the present invention is restricted thereto. Rather, it is the intention that all variations and modifications be included which fall within the spirit and scope of the appended claims.

1. An apparatus configured
to be operably connected to an access network controller device; and
to be operably connected to a pool of network elements which all comprise the same radio network configuration;
the apparatus further comprising a selection functionality configured to select and connect one or more of the network elements with the access network controller device.

2. The apparatus according to claim 1, wherein the selection functionality is a non-access stratum node selection functionality.

3. The apparatus according to claim 1, further configured to be operably connected to a radio network controller and a base station controller.

4. The apparatus according to claim 1, wherein the network elements are selected from a group comprising serving GPRS support nodes and mobile switching center server.

5. The apparatus according to claim 1, further configured to be operably connected to a pool of network elements over a multipoint interface.

6. The apparatus according to claim 1, further configured to process protocol parameter out of the group comprising temporary mobile station identity, international mobile subscriber identity, and intra domain non-access stratum node selector at level 3 signaling.

7. The apparatus according to claim 1, further configured to support one or more of the group comprising radio access network application part, base station system application part, and base station system GPRS protocol.

8. A system comprising
an access network controller device;
a pool of network elements which all comprise the same radio network configuration; and
a gateway, configured to be operably connected to the access network controller device, as well as to the pool of network elements, wherein
the gateway further comprises a selection functionality configured to select and connect one or more of the network elements with the access network controller device.

9. The system according to claim 8, wherein the selection functionality is a non-access stratum node selection functionality.

10. The system according to claim 8, wherein the gateway is further configured to be operably connected to a radio network controller and a base station controller.

11. The system according to claim 8, wherein the network elements are selected from a group comprising serving GPRS support nodes and mobile switching center server.

12. The system according to claim 8, wherein the gateway is further configured to be operably connected to a pool of network elements over a multipoint interface.

13. The system according to claim 8, wherein the gateway is further configured to process protocol parameter out of the group comprising temporary mobile station identity, international mobile subscriber identity, and intra domain non-access stratum node selector at level 3 signaling.

14. The system according to claim 8, wherein the gateway is further configured to support one or more of the group comprising radio access network application part, base station system application part, and base station system GPRS protocol.

15. The system according to claim 8, comprising at least two gateways, each of which is configured to be operably connected to the access network controller device, as well as to the pool of network elements, and each of which comprises a selection functionality configured to select and connect one or more of the network elements with the access network controller device.

16. A method comprising
selecting one or more network elements out of a pool of network elements which all comprise the same radio network configuration; and
connecting the selected one or more network elements with an access network controller device via a gateway.

17. The method according to claim 16, wherein the selecting of one or more network elements involves a non-access stratum node selection functionality.

18. The method according to claim 16, wherein the access network controller device is one of a radio network controller and a base station controller.

19. The method according to claim 16, wherein the selecting of network elements includes selecting core network elements from a group comprising serving GPRS support nodes and mobile switching center server.

20. The method according to claim 16, wherein the connecting of the selected one or more network elements includes connecting to a pool of core network elements over a multipoint interface.

21. The method according to claim 16, further comprising processing, by the gateway, protocol parameter out of the group comprising temporary mobile station identity, international mobile subscriber identity, and intra domain non-access stratum node selector at level 3 signaling.

22. The method according to claim 16, further comprising supporting, by the gateway, one or more of the group comprising radio access network application part, base station system application part, and base station system GPRS protocol.

23. The method according to claim 16, further comprising providing at least two gateways, each of which is configured to be operably connected to the access network controller device, as well as to the pool of network elements, and each of which comprises a selection functionality configured to select and connect one or more of the network elements with the access network controller device.

24. An apparatus, comprising
means for operably connecting to an access network controller device;
means for operably connecting to a pool of network elements which all comprise the same radio network configuration; and
means for selecting and connecting one or more of the network elements with the access network controller device.

25. A system comprising
means for providing access network control;
a plurality of means for providing network services which all comprise the same radio network configuration; and
gateway means for connecting to the means for providing access network control, as well as to the plurality of means for providing core network services, wherein
the gateway means comprise means for selecting and connecting one or more of means for providing network services with means for providing access network control.

26. A computer program product embodied on a computer-readable medium, the computer program product configured to provide a method comprising:
selecting one or more network elements out of a pool of network elements which all comprise the same radio network configuration; and
connecting the selected one or more network elements with an access network controller device via the media gateway.
